(19) United States
(12) Patent Application Publication
(10) Pub. No.: US 2009/0326812 A1
(43) Pub. Date: Dec. 31, 2009

(54) METHOD AND APPARATUS FOR DISPLAYING MAP BASED ON DIRECTION OF COURSE

(75) Inventors: Joong-Hwan LEE, Suwon-si (KR); Byeong-Seob Ko, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/327,269

(22) Filed: Dec. 3, 2008

(30) Foreign Application Priority Data
Jun. 25, 2008 (KR) 2008-60229

(51) Int. Cl. G01C 21/00

(52) U.S. Cl. 701/208

(57) ABSTRACT

A map displaying apparatus and method thereof, the map displaying method including: determining a course direction of an object at a current position of a map; moving a first center of a first area of the map, displayed on a screen, that is set based on the current position, by a predetermined distance in the course direction so as to determine a second center; and displaying a second area of the map on the screen having the second center as a center thereof.

### CROSS-REFERENCE TO RELATED APPLICATIONS

This application claims the benefit of Korean Patent Application No. 2008-60229, filed on Jun. 25, 2008 in the Korean Intellectual Property Office, the disclosure of which is incorporated herein in its entirety by reference.

### BACKGROUND OF THE INVENTION

1. Field of the Invention

Aspects of the present invention relate to a map displaying apparatus and method, and more particularly, to a map displaying apparatus and method by which an area in a course direction is more widely displayed on a screen.

2. Description of the Related Art

Currently, with the development of information technology (IT), navigation terminals have become widely used. A navigation system calculates a position of a local navigation terminal based on signals received from a plurality of global positioning system (GPS) satellites and displays a current position and a course to a destination of the navigation terminal on a screen.

The navigation terminals are more widely used in cars that frequently search for a course. In order to allow a driver of a car to check information on a current position and a course to a destination as rapidly as possible while driving, the information has to be appropriately displayed on a screen of the navigation terminal.

Conventional navigation terminals use various map displaying methods in order to allow the driver to easily and rapidly check the information. An example of the map displaying methods include a head-up mode method in which a map is displayed so that a current movement direction of a driver always corresponds to an upward direction of a screen. Another example is a north-up mode method in which a map is displayed so that an actual north direction always corresponds to an upward direction of a screen. A further example is a bird-view mode method in which a map is three-dimensionally displayed so that a driver can easily compare an actual driving environment to the map displayed on a screen.

However, the above map displaying methods do not display a certain area of the map that the driver may want to see on a screen.

### SUMMARY OF THE INVENTION

Aspects of the present invention provide a map displaying apparatus and method thereof whereby an area or more interest to a user is displayed on a screen, and a computer readable recording medium having recorded thereon a computer program for executing the map displaying method.

According to an aspect of the present invention, there is provided a map displaying method to display a map on a screen, the map displaying method including: determining a course direction of an object at a current position of the map; moving a first center of a first area of the map is set based on the current position, by a predetermined distance in the course direction so as to determine a second center; and displaying a second area of the map on the screen having the second center as a center thereof.

According to an aspect of the present invention, the determining of the course direction may include setting an analysis area to analyze the course direction at the current position; and analyzing a course included in the analysis area and determining a direction of the course included in the analysis area as the course direction.

According to an aspect of the present invention, the direction of the course included in the analysis area may be a direction of the course from the current position or the first center to a predetermined destination.

According to an aspect of the present invention, the determining of the direction of the course included in the analysis area may include determining a point where a course from the current position or the first center to the predetermined destination intersects a boundary of the analysis area; and determining a direction from the current position or the first center to the point on the boundary of the analysis area as the course direction.

According to an aspect of the present invention, the course direction at the current position may be a link direction at the current position.

According to an aspect of the present invention, the moving of the first center may include moving the first center by a predetermined distance in only a vertical or a horizontal direction based on the course direction so as to determine the second center.

According to another aspect of the present invention, there is provided a map displaying apparatus to display a map on a screen, the apparatus including: a course direction determination unit to determine a course direction at a current position of a map; a center movement unit to move a first center of a first area that is set based on the current position, by a predetermined distance in the course direction so as to determine a second center; and a display unit to display a second area having the second center as a center thereof.

According to another aspect of the present invention, there is provided a computer readable recording medium having recorded thereon a computer program for executing the map displaying method.

According to yet another aspect of the present invention, there is provided a map displaying method to display a map on a screen, the map displaying method including: displaying a first area of the map on the screen, the first area having a first center; determining a course direction of an object at a current position of the map; and displaying a second area of the map on the screen, the second area having a second center as a center thereof, wherein the second center is a predetermined distance away, in the course direction, from the first center.

According to still another aspect of the present invention, there is provided a map displaying apparatus to display a map on a screen, the map displaying apparatus including: a course direction determination unit to determine a course direction of an object at a current position of the map; and a display unit to change a display of a first area of the map on the screen, the first area having a first center, to a second area of the map on the screen, the second area having a second center as a center thereof, wherein the second center is a predetermined distance away, in the course direction, from the first center.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a map displaying apparatus according to an embodiment of the present invention;

FIGS. 2A through 2C are diagrams to describe a method of determining a course direction, according to an embodiment of the present invention;

FIGS. 3A through 3C are diagrams to describe a method of determining a course direction, according to another embodiment of the present invention;

FIGS. 4A through 4C are diagrams to describe methods of moving an area displayed on a screen, according to embodiments of the present invention;

FIG. 5 is a diagram to describe a method of moving an area displayed on a screen in accordance with a speed of movement, according to an embodiment of the present invention;

FIG. 6 is a flowchart of a map displaying method according to an embodiment of the present invention; and

FIG. 7 is a flowchart of a method of calling a center movement operation, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 1 is a block diagram of a map displaying apparatus 100 according to an embodiment of the present invention. Referring to FIG. 1, the map displaying apparatus 100 includes a course direction determination unit 110, a center movement unit 120, and a display unit 130. While not restricted thereto, the apparatus 100 can be included in a car, a telephone, a personal media player, a portable computer, or as a stand alone GPS unit. Further, while not shown, it is understood that the apparatus 100 can include a GPS device to determine the location and a storage device to store the map information.

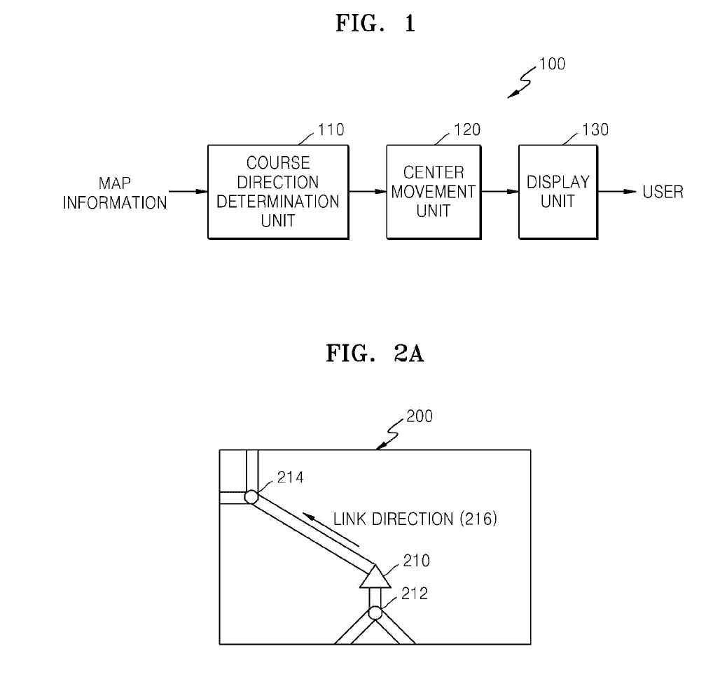

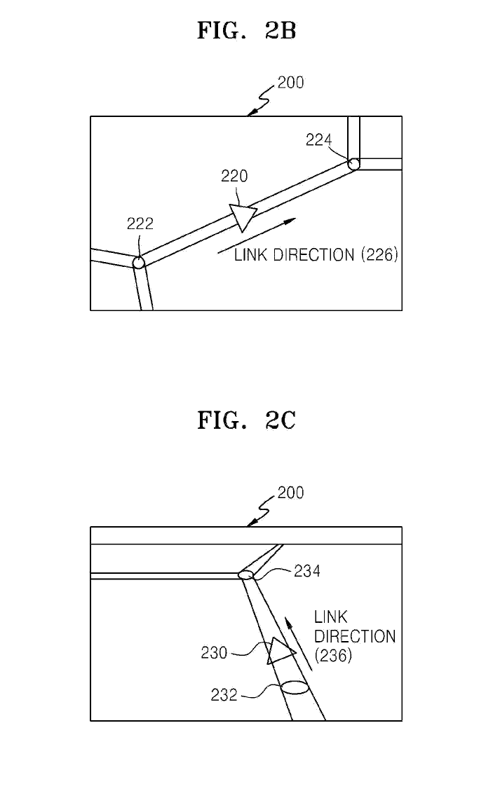

The course direction determination unit 110 determines a course direction at a current position in a first area that is set based on the current position. Accordingly, a user seeing a map displayed on a screen (such as the display unit 130) of a mobile device (such as a navigation terminal) can view information on an area that the user is going to move to, rather than information on an area that the user is moving from. Such information can include information on road conditions and points of interest (POIs) of the area that the user is going to move to. The area that the user is going to move to is determined in accordance with the course direction at the current position determined by the course direction determination unit 110. The course direction at the current position may be determined by any of a variety of methods. For example, according to aspects of the present invention, a link direction at the current position or a direction of a course, that is included in a predetermined analysis area, from the current position to a destination may be determined as the course direction at the current position. A method of determining a course direction will now be described in detail with reference to FIGS. 2A through 2C.

FIGS. 2A through 2C are diagrams to describe a method of determining a course direction, according to an embodiment of the present invention. The method illustrated in FIGS. 2A through 2C determines a link direction at a current position as the course direction. A link is a single course between two nodes and, thus, the link direction is a movement direction of a user.

FIG. 2A illustrates a head-up mode. The head-up mode displays a map so that the movement direction of the user always corresponds to an upward direction of a first area 200 on a screen that is set based on the current position. If a link from a node A 212 to a node B 214 is as illustrated in FIG. 2A, a link direction 216 is determined as the course direction at the current position. Here, the first area 200 is an area displayed on the screen when the map is displayed, regardless of the movement direction of the user (i.e., the course direction at the current position). In general, the current position is displayed on a vertical line that intersects the screen on which the map is displayed, and the first area 200 is set based on the current position.

FIG. 2B illustrates a north-up mode. The north-up mode displays the map so that an actual north direction always corresponds to the upward direction of the first area 200 on the screen. If a link from a node A 222 to a node B 224 is as illustrated in FIG. 2B, a link direction 226 is determined as the course direction at the current position.

FIG. 2C illustrates a bird-view mode. The bird-view mode three-dimensionally displays the map. If a link from a node A 232 to a node B 234 is as illustrated in FIG. 2C, a link direction 236 is determined as the course direction at the current position.

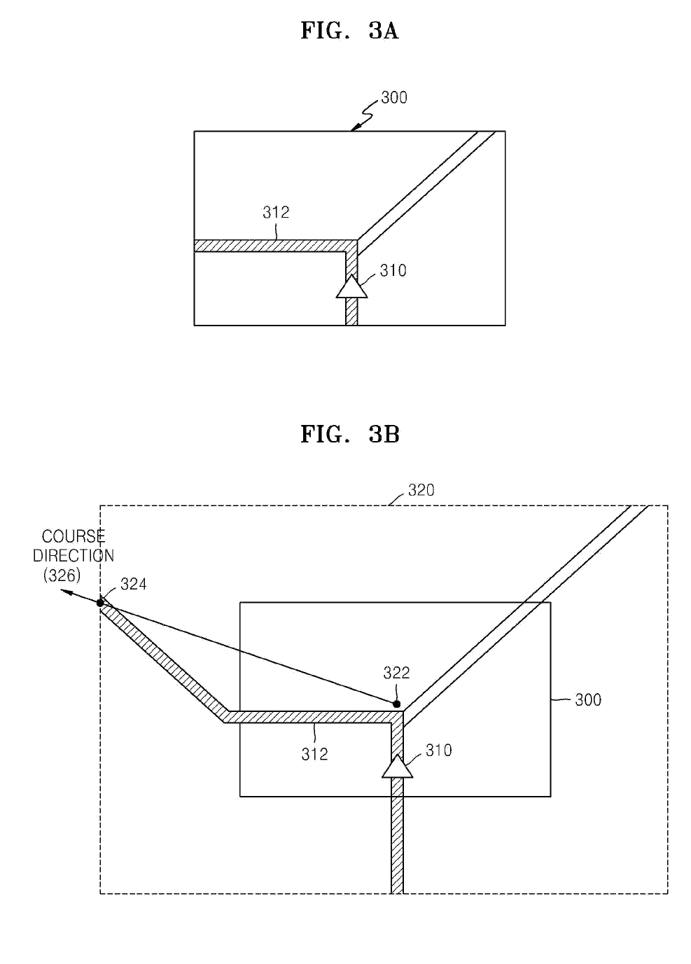

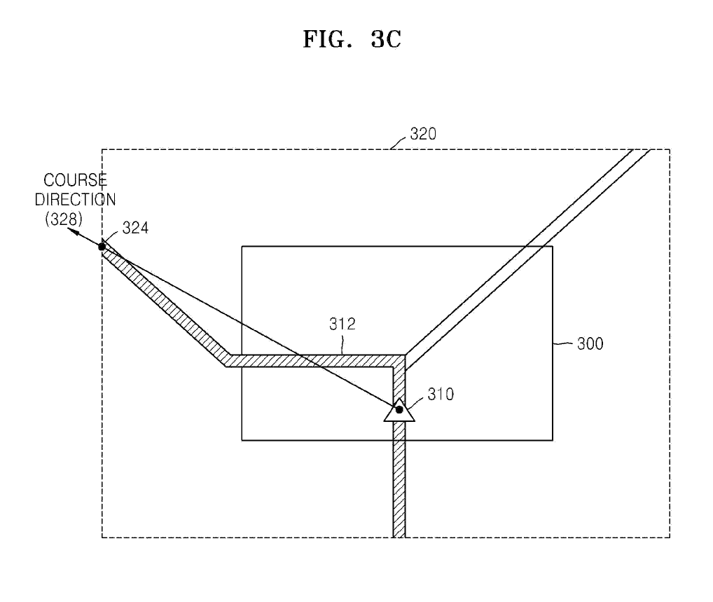

FIGS. 2A through 2C show cases when a link direction at a current position is determined as a course direction. However, if a course from the current position to a destination is detected, a direction of the detected course may be determined as the course direction at the current position. A method of determining a course direction when a course from a current position to a destination is detected will now be described in detail with reference to FIGS. 3A through 3C.

FIGS. 3A through 3C are diagrams to describe a method of determining a course direction, according to another embodiment of the present invention. Referring to FIG. 3A, a course 312 (represented as a shaded portion) from a current position 310 to a destination is detected in a first area 300.

Referring to FIG. 3B, a direction of the course 312 from the current position 310 to the destination, which is included in an analysis area 320, is determined as the course direction. The course direction determination unit 110 illustrated in FIG. 1 sets the analysis area 320 in order to analyse the course direction at the current position 310. In FIGS. 3B and 3C, a large area including the first area 300 that is set based on the current position 310 is set as the analysis area 320. However, it is understood by those of ordinary skill in the art that the same area as the first area 300 or a smaller area included in the first area 300 may also be set as the analysis area 320 according to other aspects.

When the analysis area 320 is set, the course direction determination unit 110 sets a direction 326 from a center 322 of the first area 300 to a point 324 where the detected course 312 intersects a boundary of the analysis area 320, as the course direction 326.

Alternatively, as illustrated in FIG. 3C, a direction 328 from the current position 310 (as opposed to the center 322 of the first area 300 as shown in FIG. 3B) to the point 324 where the detected course 312 meets the boundary of the analysis area 320, may be determined as the course direction 326. Accordingly, if the center 322 of the first area 300 differs from the current position 310, the direction 326 illustrated in FIG. 3B differs from the direction 328 illustrated in FIG. 3C. Although FIGS. 3A through 3C are described based on a head-up mode, it is understood that the same method may be applied to a north-up mode or a bird-view mode shown in FIGS. 2B and 2C.

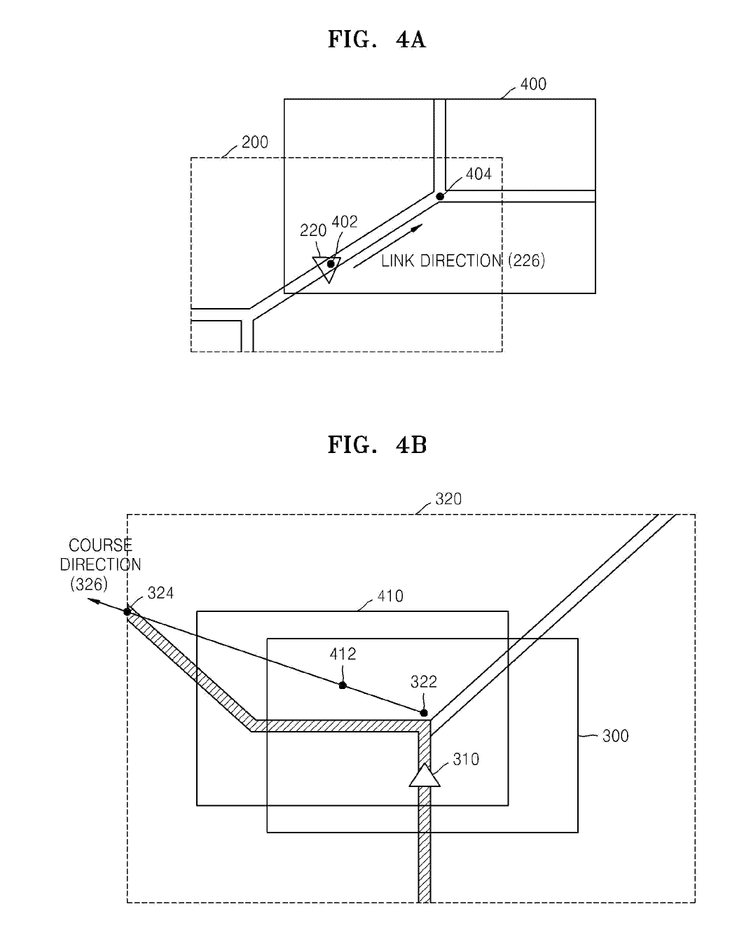

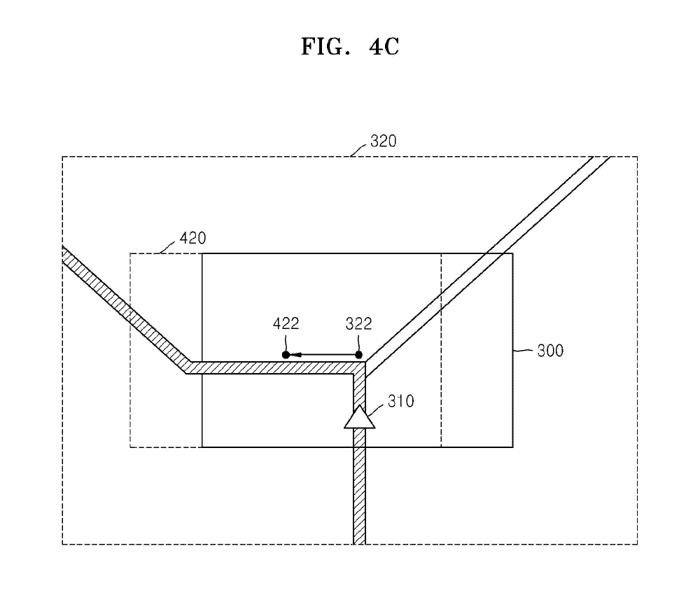

Referring back to FIG. 1, the center movement unit 120 moves a first center of the first area to a second center in accordance with the course direction at the current position, determined by the course direction determination unit 110. The display unit 130 displays a second area having the second center on a screen. Thus, the first area displayed on the screen moves to the second area. A method of moving an area displayed on a screen will now be described in detail with reference to FIGS. 4A through 4C.

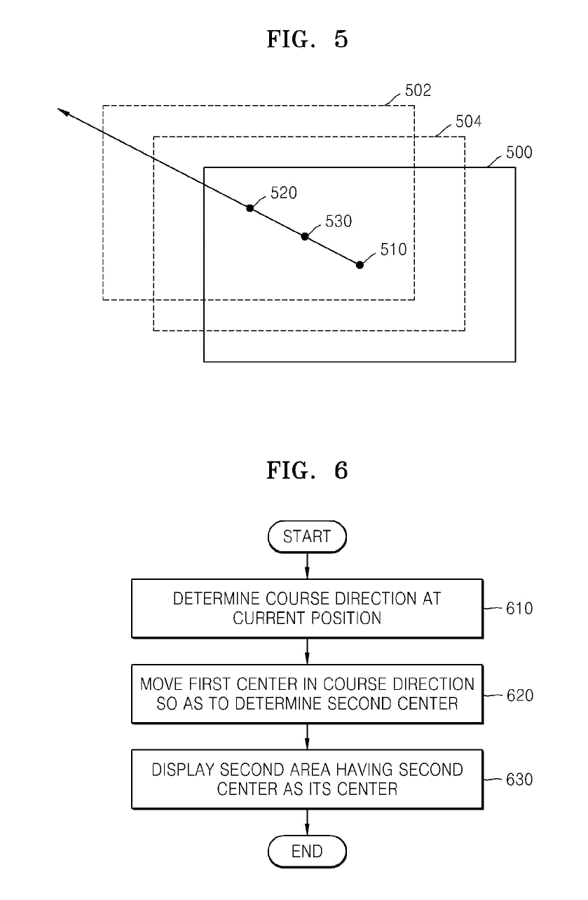

FIGS. 4A through 4C are diagrams to describe methods of moving an area displayed on a screen, according to embodiments of the present invention. FIG. 4A illustrates a method of moving an area displayed on a screen when a course direction at a current position 220 is determined as illustrated in FIG. 2B. Referring to FIG. 4A, the center movement unit 120 moves a first center 402 of a first area 200 that is set based on the current position 220, in a link direction 226 that is determined by the course direction determination unit 110, so as to determine a second center 404. A movement distance from the first center 402 to the second center 404 may differ in accordance with embodiments of the present invention. In particular, the movement distance can vary as long as the current position 220 can be displayed on the screen. Furthermore, the movement distance may adaptively differ in accordance with a user's speed of movement, which will be described in detail later with reference to FIG. 5. When the second center 404 is determined, the display unit 130 displays a second area 400 having the second center 404 as its center, on the screen. Although FIG. 4A is described based on a north-up mode, it is understood that the same method may be applied to a head-up mode or a bird-view mode.

FIG. 4B illustrates a method of moving an area displayed on a screen when a course direction at a current position 310 is determined as illustrated in FIG. 3B. Referring to FIG. 4B, the center movement unit 120 moves a first center 322 of a first area 300 that is set based on the current position 310, in a direction 326 that is determined as the course direction in FIG. 3B, so as to determine a second center 412. A movement distance from the first center 322 to the second center 412 can vary, according to aspects of the present invention, as long as the current position 310 can be displayed on the screen. Although FIG. 4B is described based on the direction 326 illustrated in FIG. 3B, the same method may be applied when the direction 328 illustrated in FIG. 3C is determined as the course direction. For example, the first center 322 of the first area 300 may move by a predetermined distance in the direction 328 illustrated in FIG. 3C instead of the direction 326 illustrated in FIG. 3B, so as to determine a different second center. Accordingly, when the second center 412 is determined, the display unit 130 displays a second area 410 having the second center 412 as its center, on the screen. Although FIG. 4B is described based on a head-up mode, it is understood that the same method may be applied to a north-up mode or a bird-view mode.

FIG. 4C illustrates a method of moving an area displayed on a screen, according to another embodiment of the present invention. Referring to FIG. 4C, the center movement unit 120 moves a first center 322 of a first area 300 in only a vertical or a horizontal direction based on a course direction at a current position 310. For example, in FIG. 4C, the center movement unit 120 moves the first center 322 in only the horizontal direction so as to determine a second center 422.

Specifically, if the course direction is a vertical or a horizontal direction, the first center 322 respectively moves in the vertical or the horizontal direction. However, if the course direction is a top-left direction as illustrated in FIG. 3B or FIG. 3C, the first center 322 does not move in a top-left direction in the current embodiment. Based on a vertical or horizontal component of the course direction, the first center 322 moves in only the vertical or the horizontal direction so as to determine the second center 422.

The method illustrated in FIG. 4C may be applied to a head-up mode, a north-up mode, or a bird-view mode. However, according to other aspects, the first center 322 may move based on only a horizontal component of the course direction, so as to determine the second center 422, in the head-up mode or the bird-view mode.

FIG. 5 is a diagram to describe a method of moving an area displayed on a screen in accordance with a speed of movement, according to an embodiment of the present invention. Referring to FIG. 5, a movement distance of a first center 510 may differ in accordance with a user's speed of movement. If the user's speed of movement is relatively high (for example, greater than a predetermined speed), the first center 510 moves to a second center 520 so that the user can view information on an area that is relatively farther from the current position in a movement direction. As illustrated, a distance between the first center 510 and the second center 520 is relatively large. Accordingly, a displacement between a first area 500 having the first center 510 as its center and a second area 502 to be displayed on the screen is also respectively large.

On the other hand, if the user's speed of movement is low (for example, less than a predetermined speed), the first center 510 moves to a second center 530 so that the user can view information on an area that is relatively closer to the current position in the movement direction. As illustrated, a distance between the first center 510 and the second center 530 is relatively small. Accordingly, a displacement between the first area 500 having the first center 510 as its center and a second area 504 to be displayed on the screen is smaller than the case when the user's speed of movement is high.

FIG. 6 is a flowchart of a map displaying method according to an embodiment of the present invention. Referring to FIG. 6, a map display apparatus determines a course direction at a current position in operation 610. As described above with reference to FIGS. 2A through 2C and 3A through 3C, a link direction at the current position or a direction of a course, that is included in a predetermined analysis area, from the current position to a destination is determined as the course direction, though it is understood that aspects of the present invention are not limited thereto.

The map display apparatus moves a first center of a first area that is set based on the current position by a predetermined distance in the course direction that is determined in operation 610, so as to determine a second center in operation 620. The first area is set regardless of the course direction at the current position and is an area displayed on a screen when a map is displayed in a display mode (such as a head-up mode, a north-up mode, or a bird-view mode).

Accordingly, the map display apparatus displays a second area having the second center that is determined in operation 620, as its center on the screen in operation 630. The second area is set based on the second center that is moved from the first center of the first area, and is displayed on the screen. Since the second center is determined based on the course direction at the current position, the second area is moved from the first area by the predetermined distance in the course direction.

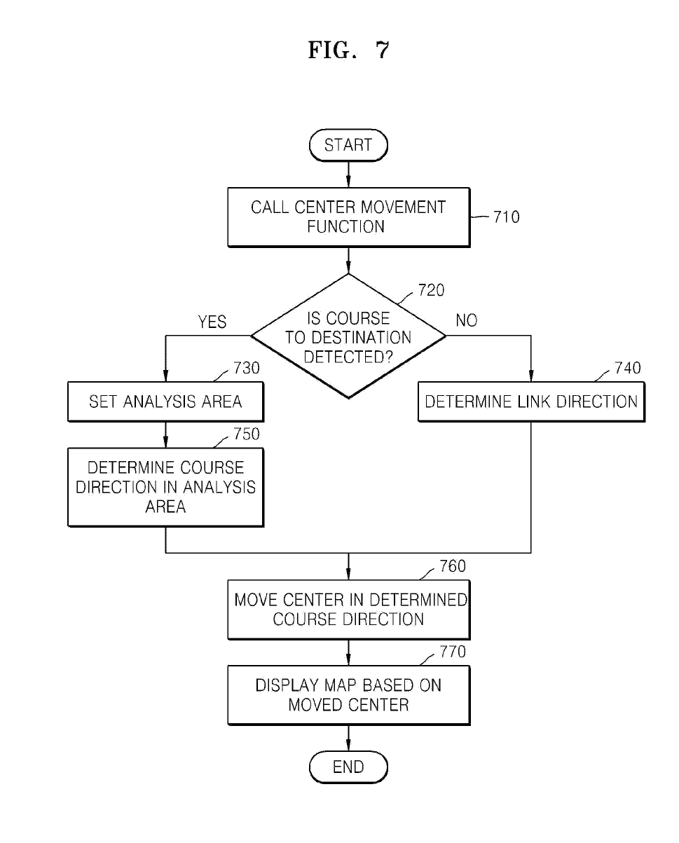

FIG. 7 is a flowchart of a method of calling a center movement operation, according to an embodiment of the present invention. In FIG. 7, a method of applying a map displaying operation is illustrated, in which an area that is moved from a first area by a predetermined distance based on a course direction at a current position is displayed on a screen as described above with reference to FIGS. 1, 2A through 2C, 3A through 3C, 4A through 5C, 5, and 6.

Referring to FIG. 7, a map display apparatus according to an embodiment of the present invention calls the center movement operation in operation 710. Then, the map display apparatus determines whether a course from a current position to a destination is detected in operation 720. Different methods of determining a course direction at the current position can be used according to whether the course from the current position to the destination is detected.

If it is determined that the course from the current position to the destination is detected (operation 720), an analysis area is set in order to analyze the course in operation 730. When the analysis area is set (operation 730), the map display apparatus determines the course direction in the analysis area in operation 750. For example, a point where the detected course intersects a boundary of the analysis area is determined and a direction from the current position or a first center of the first area to the determined point may be determined as the course direction. However, it is understood that a method of determining a course direction is not limited to the method described above with reference to FIGS. 3A through 3C.

If it is determined that the course from the current position to the destination is not detected (operation 720), the map display apparatus determines a link direction as the course direction in operation 740. A link is a single course between two nodes and thus the link direction is a movement direction of a user on the link. Accordingly, the link direction is determined as the course direction.

The map display apparatus moves the first center of the first area in the determined course direction (operation 740 or 750), so as to determine a second center in operation 760. Operation 760 corresponds to operation 620 illustrated in FIG. 6. Accordingly, the map display apparatus displays a second area having the second center as its center, on the screen, in operation 770.

The method illustrated in FIG. 7 is exemplarily described and it will be easily understood by those of ordinary skill in the art that various other methods may also be used. Furthermore, it is understood that the center movement operation may be selectively used. For example, the map display apparatus may or may not use the center movement operation in accordance with a user's input. Also, if an exceptional case happens (for example, if the user departs from the course), the center movement operation may not be used and the first area that is set based on the current position may be displayed on the screen. In this case, according to an embodiment of the present invention, the center movement operation may not be used if the user departs from the course by more than a predetermined distance. Alternatively, if the exceptional case happens, the center movement operation may be re-called.

As described above, according to aspects of the present invention, an area in a course direction may be more widely displayed on a screen and, thus, a user may rapidly check information on an area that the user is going to. Accordingly, a driver may safely drive a car by easily predicting a course.

While aspects of the present invention have been particularly shown and described with reference to embodiments thereof, it will be understood by those of ordinary skill in the art that various changes in form and details may be made therein without departing from the spirit and scope of the invention as defined by the appended claims. Also, aspects of the present invention can also be embodied as computer-readable codes on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A map displaying method to display a map on a screen, the map displaying method comprising:
determining a course direction of an object at a current position of the map;
moving a first center of a first area of the map, displayed on the screen, that is set based on the current position, by a predetermined distance in the determined course direction so as to determine a second center; and
displaying a second area of the map on the screen having the determined second center as a center thereof.

2. The map displaying method as claimed in claim 1, wherein the determining of the course direction comprises:
setting an analysis area to analyze the course direction at the current position; and
analyzing a course included in the analysis area and determining a direction of the course included in the analysis area as the course direction.

3. The map displaying method as claimed in claim 2, wherein the direction of the course included in the analysis area is a direction of the course, that is included in a predetermined analysis area, from the current position or the first center to a predetermined destination.

4. The map displaying method as claimed in claim 2, wherein the determining of the direction of the course included in the analysis area comprises:
determining a point where a course from the current position or the first center to a predetermined destination intersects a boundary of the analysis area; and
determining a direction from the current position or the first center to the point on the boundary of the analysis area as the course direction.

5. The map displaying method as claimed in claim 1, wherein the course direction at the current position is a link direction at the current position.

6. The map displaying method as claimed in claim 1, wherein the moving of the first center comprises moving the first center by the predetermined distance in only a vertical or a horizontal direction based on the course direction so as to determine the second center.

7. The map displaying method as claimed in claim 6, wherein the moving of the first center in only the vertical or the horizontal direction comprises moving the first center in only the horizontal direction when the map is in a head-up mode or a bird-view mode.

8. The map displaying method as claimed in claim 6, wherein the moving of the first center in only the vertical or the horizontal direction comprises:
moving the first center in only the horizontal direction if a horizontal component of the course direction is greater than a vertical component of the course direction; and
moving the first center in only the vertical direction if the vertical component of the course direction is greater than the horizontal component of the course direction.

9. The map displaying method as claimed in claim 1, wherein the moving of the first center comprises:
moving the first center by a first distance in the course direction when a moving speed of the object is a first speed; and
moving the first center by a second distance, less than the first distance, when the moving speed of the object is a second speed, less than the first speed.

10. A map displaying apparatus to display a map on a screen, the map displaying apparatus comprising:
a course direction determination unit to determine a course direction of an object at a current position of the map;
a center movement unit to move a first center of a first area of the map, displayed on the screen, that is set based on the current position, by a predetermined distance in the determined course direction so as to determine a second center; and
a display unit to display a second area of the map on the screen having the determined second center as a center thereof.

11. The map displaying apparatus as claimed in claim 10, wherein the course direction determination unit sets an analysis area to analyze the course direction at the current position, and analyzes a course included in the analysis area to determine a direction of the course included in the analysis area as the course direction.

12. The map displaying apparatus as claimed in claim 11, wherein the direction of the course included in the analysis area is a direction of the course, that is included in a predetermined analysis area, from the current position or the first center to a predetermined destination.

13. The map displaying apparatus as claimed in claim 11, wherein the course direction determination unit determines a point where a course from the current position or the first center to a predetermined destination intersects a boundary of the analysis area, and determines a direction from the current position or the first center to the point on the boundary of the analysis area as the course direction.

14. The map displaying apparatus as claimed in claim 10, wherein the course direction at the current position is a link direction at the current position.

15. The map displaying apparatus as claimed in claim 14, wherein the center movement unit moves the first center by the predetermined distance in only a vertical or a horizontal direction based on the course direction so as to determine the second center.

16. The map displaying apparatus as claimed in claim 15, wherein the center movement unit moves the first center in only the horizontal direction when the map is in a head-up mode or a bird-view mode.

17. The map displaying apparatus as claimed in claim 15, wherein the center movement unit moves the first center in only the horizontal direction if a horizontal component of the course direction is greater than a vertical component of the course direction, and moves the first center in only the vertical direction if the vertical component of the course direction is greater than the horizontal component of the course direction.

18. The map displaying apparatus as claimed in claim 10, wherein the center movement unit moves the first center by a first distance in the course direction when a moving speed of the object is a first speed, and moves the first center by a second distance, less than the first distance, when the moving speed of the object is a second speed, less than the first speed.

19. A computer readable recording medium having recorded thereon a computer program for executing the map displaying method of claim 1.

20. A map displaying method to display a map on a screen, the map displaying method comprising:
displaying a first area of the map on the screen, the first area having a first center;
determining a course direction of an object at a current position of the map; and
displaying a second area of the map on the screen, the second area having a second center as a center thereof,
wherein the second center is a predetermined distance away, in the determined course direction, from the first center, and the course direction is independent of a movement direction of the object.

21. A computer readable recording medium having recorded thereon a computer program for executing the map displaying method of claim 20.

22. A map displaying apparatus to display a map on a screen, the map displaying apparatus comprising:
a course direction determination unit to determine a course direction of an object at a current position of the map; and
a display unit to change a display of a first area of the map on the screen, the first area having a first center, to a second area of the map on the screen, the second area having a second center as a center thereof,
wherein the second center is a predetermined distance away, in the course direction, from the first center, and the course direction is independent of a movement direction of the object.
